(19) United States
(12) Patent Application Publication
(10) Pub. No.: US 2011/0202512 A1
(43) Pub. Date: Aug. 18, 2011

(54) METHOD TO OBTAIN A BETTER UNDERSTANDING AND/OR TRANSLATION OF TEXTS BY USING SEMANTIC ANALYSIS AND/OR ARTIFICIAL INTELLIGENCE AND/OR CONNOTATIONS AND/OR RATING

(76) Inventors: Georges Pierre Pantanelli, Santa Rosa, CA (US); Philippe Montesinos, Milhaud (FR)

(21) Appl. No.: 12/705,616

(22) Filed: Feb. 14, 2010

(51) Int. Cl. G06F 17/21; G06F 17/30; G06Q 30/00; G06F 17/27

(52) U.S. Cl. 707/706; 705/14.49; 704/9; 704/E15.018

(57) ABSTRACT

A machine based analysis engine method to obtain a better understanding of written texts by using Contextual and Semantic Analysis with Artificial Intelligence is described.
This method applies to rendering refined targeted advertisement's display.
This method applies to rendering enhanced search engines' results.
This method allows natural language awareness rendering accurate results.
This method applies to any texts enhancing document translation.

### FIELD OF THE INVENTION

The embodiments of the invention generally relates to a system and method to understand and/or translate texts from one language to another by using Semantic Analysis, and/or Artificial Intelligence, and/or Contextual Analysis, and/or Rating.

### BACKGROUND

There is a need to better understand documents' content using machines such as computers. Making a deep analysis of documents and solving ambiguities on words, analyzing relations between words, etc, permits to better understand texts, messages, etc, and to better rank websites and all types of documents on search engines, to refine search results on search engines, and to better display targeted advertising on Internet or on user's PC.

A good analysis of documents is necessary to perform a good translation, generally the analysis phase is the most critical and complicate phase in the translation process.

This in depth analysis of documents permitting to know the complete structure of every sentence, and to solve all the grammatical and semantic ambiguities, having all those precise informations we can deduct a lot of informations that a superficial analysis has ignored, as for example connotations, ratings on words, etc.

Our invention is demonstrated in two applications:

1—Document translation costs billions of dollars annually worldwide to governments and corporations, and these needs for translation are growing rapidly. Our method has been developed to address the growing demand and to expand the usage of many applications across language barriers to a global scale.

Many techniques are available to understand and/or to translate any language. Several Corporations are offering translation. Those techniques are using Machine Translation mainly based on ideally and standard written format language using Statistical Analysis.

2—Content analysis to render better targeted advertising and refining searches

It adds value to many applications such as documents, web pages, targeted advertising on Internet, search query, messaging/SMS, chat, email, corporate communications, news, web page translation, vocal softwares, phone applications (voice over IP, cell phone, smart phone), advertising, and more.

Our method using Algorithmic Contextual Analysis, Semantic Analysis, and/or Artificial Intelligence, and/or connotations, and/or rating, jargon awareness, and rich dictionaries renders accurate results even with unexpected combinations of words and thoughts. It is lightweight, fast, modular, and runs on end-user computing devices without requiring a network connection.

In the present patent the terms “document” or “text” includes any type of document, web page, search query, SMS, chat, email, short message on messengers, news, vocal softwares, phone applications (voice over IP, cell phone, smart phone), voice analyzed by automatic recognition softwares (for phone applications, videos, etc), etc.

The term “document” includes anything written, in any language, in any alphabet.

The term “document” includes anything written in shorten languages, such as acronyms, SMS languages, jargon, etc.

The term “document” includes anything written in a graphical language, pictorial, emoticons, “smileys”, etc.

The term “document” includes anything said, in any language.

The term “document” includes the voice transformed in text by automatic recognition softwares.

The term “document” includes anything written or said, processed by any mean, and on any support.

The term “document” includes multiple forms of “documents” as indicated before, those “documents” being mixed, for example usual language and acronyms and emoticons.

The term “document” includes anything being written or said in real time or being stored.

The terms “document” includes anything being written or said used on servers or on end-user devices (computers, cell phones, smart phones, and all kind of electronic devices) with or without a network connection, or used in cloud computing.

### DETAILED DESCRIPTION

In the following a detailed description of the embodiments of the invention, abundant fine points are set forth in order to provide a meticulous understanding of the embodiment of the invention. The details are limited to the well known state of the art so as not to obscure many aspects of the embodiments of the invention.

As the invention is able to process all existing languages, in the following detailed description of the invention we are using examples in English and French, to show that this invention is not limited to the English language.

The invention relates to methods and systems to obtain a better understanding and/or translation of document using Contextual Analysis, Semantic Analysis and Artificial Intelligence. This software uses Algorithmic Contextual Analysis, Semantic Analysis, and Artificial Intelligence, jargon awareness, and rich dictionaries to render accurate results even with unexpected combinations of words and thoughts.

The invention relates to a method and system using a specific dedicated analysis and/or translation module that is lightweight, fast, modular, and runs on end-user computing devices with network connection or without requiring a network connection. It adds value to many applications such as document processing, search query, messaging/SMS, chat, email, corporate communications, news, web page translation, vocal softwares, phone applications (voice over IP, cell phone, smart phone), advertising, and more.

All the methods described in the present patent can be used on servers or on end-user devices (computers, cell phones, smart phones, and all kind of electronic devices) with or without a network connection.

All the methods described in the present patent can be used in cloud computing. All the methods described in the present patent can be used in real time, or in batch mode, or in preprocessed treatments.

The invention will interpret any character protocols within a text such as ASCII, Unicode, UTF 8, etc. The invention is not limited to existing protocols.

The term “device” includes any type of computing apparatus such as PC, laptop, hand-held device, smart phone, or server that is capable of storing, processing, or receiving any information.

FIG. 1 is a block diagram illustrating how one embodiment of the invention is implemented. From an original text 100 the character format is identified automatically 101. The invention is not limited to the automatic character identification; those skilled in the state of the art will recognize that the invention is applicable if the character format were preset or defined. The portions that do not require analysis and/or translation such as “emoticons”, HTML elements within web page source code, comments within software source code, and symbols are identified and removed to be re-incorporated within the analyzed and/or translated text 102. In 105 text formatting and spelling is checked, with correctly spelled words identified in 106 to create naturalized text for 110, and special formatting and repeated characters are identified in 107 for later reincorporation in 150. Naturalized text 110 is ready for analysis and/or translation 120 if necessary in our Language Translation Service Module (LTSM) in 130. Analyzed and/or translated text is produced in 140, then re-formatting and character counts will be re-incorporated in 150 to create the finalized analyzed and/or translated text 160.

A method to improve the quality of the analysis and/or the translation is in a step of pre-treatment of the text, to detect words that are misspelled and to modify them before the analysis and/or the translation. In the step of analyzing words, if a word is not recognized in the database, and after changes to see if it is not a feminine, a plural or a conjugated verb.

It is possible for example to see if a letter which is doubled in a properly written word has been omitted and is present only one time, for example: “leter” and not “letter”.

Or for example in languages like French, to see if accents are correct, for example: “trés” for “très”.

Or for example in languages like French, to see if groups of letters having the same sound are correctly spelled, for example “o” “au” “eau” have the same sound, and the word “bateau” can be misspelled “bato” or “batau”. Spelling is checked in 105.

Those corrections apply directly for messages such as in SMS, chat, short messages on messengers, etc, acronyms are widely used, we can analyze acronyms and make a translation of acronyms to correct language in 105. So we can correctly analyze and/or translate documents, web pages, SMS, chat, emails, short messages on messengers, etc, containing acronyms.

FIG. 2 shows a list of all information required and necessary for the invention to be implemented for any language. Analysis and/or Translation Dictionary 210; dictionary of synonyms 215; key words 220 are defined such as definite/indefinite articles 221, numeral adjectives 222, personal pronouns 223, etc. 224; gender and plural words are identified 230 masculine/feminine determination as required for several languages 231 and plural formats 232; verb conjugations 240 will identify groups, including regular and irregular verbs 241. Several contextual concepts are recognized 250 such as words with same entries but different meanings 251 and associated words 252. In 260 for all language the word order is identified, e.g. in English the adjective is always before the noun. Tables for First name 265, geographical name 270, and acronyms 275 are compiled. Any particularity 280 such as color 281, country names 282, etc. 283 are also compiled. For each language a set of test sentences are prepared 290 which are either typical sentences 291 and any published documents 292 to be run to test the analysis and/or translation quality.

FIG. 3 shows how in an original text 301 each word is grammatically analyzed 302 and identified before translation to create word format tables 310 which are defined for example as: name with gender 311, verb with conjugation tense and format 312, adjective 313, pronoun 314, adverb 315 etc. 316. Those skilled in the state of the art will recognize that a word might have many different grammatical classifications. The invention relates to a Contextual and Semantic Analysis associated with Artificial Intelligence to analyze and identify within a sentence or text the proper classification. The methodology is described in a later paragraph.

FIG. 4 shows a Cross Dictionary Table in French 400 illustrating how one embodiment of the invention is implemented. These tables create lightweight and efficient Contextual and Semantic Analysis databases. All entries described in FIG. 4 are sorted and indexed 401. These entries are stored for each basic entry under a data system from aaa 402, aab 403, aac 404 to zzx 404, zzy 406 and zzz 407 for each language. A specific example the 410 is shown for French words. Entry such as “chef” 411 is indexed 412 to “chez” 421 with respective index 420. To increase Contextual and Semantic Analysis search efficiency, an example is shown for the name “cheval” (horse) 415 with index 414 linked to an irregular plural “chevaux” (plural form of horse in French) 417 with index 416.

The invention is not limited to this example; those skilled in the state of the art will recognize that the invention is applicable for irregular verbs, adjectives and other specific grammatical or linguistic informations.

FIG. 5 shows how Cross Dictionary tables are inter-linked. This figure shows a link between the French table 510 and the English table 520. Furthermore a link between “cheval” (horse) 512 its index 511 associated with the plural 514 and index 513 is linked to the English table respectively to “horse” 522 with index 521. It is thus clear that the index of “cheval” (horse) 511 is directly linked to the index of “horse” 521 in the invention. This linkage of indexes is bi-directional 530 and will render any contextual search efficient and fast. This Cross bi-directional index linkage decreases the independent storage of information and contributes to create a lightweight and modular translator.

Those skilled in the state of the art will recognize that the invention is not limited to the French and English examples but is applicable to any language.

FIG. 6 shows a diagram of an Analysis using Artificial Intelligence. A sentence 600 is analyzed by the Artificial Intelligence module 601 into subsets 602. In the French sentence “les deux jolis chats blancs courent vite” (The two pretty white cats run fast); “les deux” 610 is found to be a combination of a definite article “les” 611 and a numeral adjective “deux” 612 to form the sentence determinant. The next sentence subset “jolis chats blancs” 620 is a combination of “jolis” 622 a qualitative adjective, “chats” a plural noun 623; and again a qualitative adjective “blancs”, the last subset “courent vite” 630 form a verbal group with “courent” a verb 631 and “vite” adverb 632. Each subset which had been identified using the Artificial Intelligence Analysis are therefore translated properly into English: “The two pretty white cats run fast” 650. In the translated sentence “two” is the determinant 651, “pretty white cats” the nominal group 652 and “run fast” the verbal group 653.

It is also shown that in English an adjective is always before a noun and that the second adjective “blancs” as been translated to “white” and positioned with the first adjective “pretty” before the noun.

The analysis is shown from French to English but is conducted in a similar manner from English to French by using the Artificial Intelligence part of the method.

Those skilled in the state of the art will recognize that the invention is not limited to the French and English examples but is applicable to any language.

FIG. 7 shows a diagram of how priority structures 700 are determined and identified using Analysis with Artificial Intelligence 701. English “clean” 702 might be a qualitative adjective 711 and will be translated into French as “propre” 710; this is determined to always be the case following the verb “to be”. In the sentence “he is clean” a simple analysis properly translates it to “il est propre”. English “clean” 702 might also be an adverb 730 and be translated as “proprement” 731 and in the following sentence “he washes clean” 740 again using Analysis with Artificial Intelligence properly translated as “il lave proprement” 741.

Those skilled in the state of the art will recognize that the invention is not limited to the French and English examples but is applicable to any language.

All methods described in the present patent are applicable to any language, using any alphabet, whatever grammatical rules are included in those languages.

For example all methods described in the present patent are applicable to the Chinese language (being using pictograms or pinyin), to Latin languages, to Anglo-Saxon languages, to Arab languages, to Greek, etc. There is no limit in languages that can be processed with all methods described in the present patent.

We can try to determine the grammatical type of each word starting from the first word to the last one, using the word before and the word after.

But very often it is not enough, particularly in English.

In English to solve this problem it is very difficult because there are only four possible endings for verbs, at the contrary of verbs in Latin languages which have a lot of possible endings.

In Latin languages qualifying adjectives have the same gender and number than the word they are qualifying, in English it is not the case.

For example in Latin languages they are more determinants than in English language. Etc.

For example in French: “il ouvre la porte, puis il la ferme” (he opens the door, then he closes it).

If we analyze the sentence: “puis il la ferme”:
“puis” may be a conjunction or the verb “pouvoir”,
“il” is a personal pronoun (subject),
“la” may be definite article or personal pronoun (complement),
“ferme” may be qualifying adjective or noun or verb.

It is possible to think that “la ferme” has the grammatical structure: definite article+noun.

But if we look further to a more extended part of the sentence “il la ferme”,

we see that this part of the sentence has the structure: personal pronoun (subject)+personal pronoun (complement)+verb.

So we see that we must consider the largest possible group of words.

We can solve this problem with artificial intelligence:

We can use a method consisting to determine all the structures that are grammatically possible for a sentence, then to look which one is probably the most correct on the grammatical point of view.

Joining Words Together to Form Structures that are Grammatically Possible.

The number of structures grammatically possible is infinite, like the number of sentences possible in a language, so we cannot have a complete list of all the structures that are possible.

To obtain the structure or the structures that are grammatically possible for a sentence we can use the following method:

we join together words in logic units, those logic units becoming more and more complex.

Joining those words into logic units is made in a precise order.

For example: “two of those persons”.

With the sentence: “the two beautiful big black cars are running very fast”

We join words to form groups of determinants, for example “the two”: definite article+numeral adjective.

We join words to form nominal groups, including determinants, for example “the two big beautiful black cars”: definite article+numeral adjective+qualifying adjective+qualifying adjective+qualifying adjective+noun.

We join words to form verbal groups, for example “are running very fast”: verb+adverb+qualifying adjective.

Then we join nominal groups+verbal groups to form sentences.

An inference engine applies those rules on sentences structures.

### Priority Structures:

When we have a list of structures that are grammatically possible, we must select the one which is probably the most correct.

Considering that in English, words have very often more than one grammatical type, for example, words having the grammatical type qualifying adjective have very often moreover the grammatical type adverb, both being possible even in the same sentence.

For example the word “clean” can be qualifying adjective or adverb.

For example the sentence“it is clean” has a grammatical structure: pronoun+verb+qualifying adjective.

And the sentence“it washes clean” has a grammatical structure: pronoun+verb+adverb.

So with the same word “clean” both structures are grammatically correct.

After linguistic studies, we can see that if there is a choice between the structure: verb+qualifying adjective and the structure: verb+adverb, the structure: verb+adverb is the correct one.

But in the case where the verb is “to be” it is managed in another way.

So if there is a choice between the structure: “to be”+qualifying adjective and the structure: “to be”+adverb, the structure: “to be”+qualifying adjective is the correct one.

Those examples are given to explain the logic of the selection.

An inference engine applies those rules on structures of sentences to determine priority structures.

A data base contain a list of structures having priority on other structures.

The invention is not limited to the above example or languages. Those skilled in the state of the art will recognize that the invention is applicable to many combinations or variations that exist.

FIG. 8 shows a diagram for how words with many meanings 800 are determined and identified using Semantic Analysis 801. French word “glace” 802 a noun might mean in English “to be eaten” 811 and will be translated as “ice cream” 810. “L'enfant mange la glace” 820 is in that context properly translated to “the child eats the ice cream” 821. The contextual analysis has found “glace” (ice cream) to be associated with “mange” (to eat) and has correctly given the right contextual translation. The word “glace” 802 in French could be linked in English “to look at” 830 and will be translated to “mirror” 831. “Je me regarde dans la glace” 840 is in that context properly translated in “I look at myself in the mirror”. The semantic analysis has found “glace” to be associated with “regarde” and has correctly given the right contextual translation. “Glace” 802 in French might be linked in English “to water” 850 and will be translated as “ice” 851. “la glace est de l'eau gelée” 860″ is in that context properly translated to “ice is frozen water” 861. The contextual analysis has found “glace” 802 to be associated with “water” and has correctly given the right contextual analysis and/or translation.

The invention is not limited to the above example or language. Those skilled in the state of the art will recognize that the invention is applicable to many combinations or variations, not limited to analysis of a single sentence analysis but could be extended to include nearby text.

FIG. 9 shows as in FIG. 8 a diagram for how words with many meanings 900 are determined and identified using Contextual Analysis 901. French word “voler” 902 as a verb might mean in English a “legal concept” 911 and will be translated as “to steal” 910. “L'homme vole l'orange” is in that context properly translated to “the man steals the orange” 921. The contextual analysis has found “vole” 901 to be associated with “orange” which is not a flying object and has given the proper analysis and/or translation. “Voler” in French might mean in English to be an “aeronautic concept” 930. ‘Le pilote vole en avion” 940 is properly analyzed and/or translated in the context as “the pilot flies in a plane” 941. The contextual analysis has found both a pilot and an airplane and has given the proper analysis and/or translation.

The invention is not limited to the above example or language. Those skilled in the state of the art will recognize that the invention is applicable to many combinations or variations that exist or will exist.

FIG. 10 shows a diagram in which the embodiment of the invention may be implemented using synonym association with Semantic Analysis and Contextual Analysis. In French for “glace” to be a “sorbet” 1000 a Semantic Contextual analysis 1001 will compile and look for synonyms in the context of “manger” 1003. When a synonym or context meaning is identified the Semantic, Contextual Analysis 1001 will translate “glace” to “ice cream” in English 1004. This analysis 1002 is shown for French “l'enfant a une glace au diner” to be translated in English as “the child has an ice cream for dinner”. In this example the contextual connection was “diner”.

It is also shown that a misspelled word “dîner” was correlated to “diner”, which is properly spelled with the accented character “î” in French.

In another example 1006 “L'enfant savoure une glace” through the recognition of the word “savoure” is correctly translated to “The child savors an ice cream”.

In a similar approach “glace” is identified as a “miroir” 1010 by Contextual and Semantic Analysis 1001 through association with “regarder”, etc. 1011, to be analyzed and/or translated contextually 1001 to English as “mirror” 1012. This analysis is shown for the French sentence “la fille se voit dans la glace” to be contextually correctly translated to English “the young girl sees herself in the mirror” 1013. A similar analysis will translate the French “le soleil se reflète dans la glace” to “the sun is reflected in the mirror” 1014.

FIG. 11 shows a diagram in which the embodiment of the invention may be implemented using the Semantic and Contextual Analysis with Artificial Intelligence to augment a Statistical translator. A text to be analyzed and/or translated 1101 is first entered in the Statistical Server module 1102. Pre-analyzed and/or pre-translated sentences are found 1103 and the analyzed and/or translated text is generated 1111. If no complete pre-translation for sentences are found 1104, a status analysis is performed 1105 and several possibilities are reported such as missing words 1106, text not found 1107, sentences involved different verb tenses 1108, text analysis and/or translation was accomplished using too small pre-analyzed and/or pre-translated text 1109, etc. and the test is run using the Contextual and Semantic Analysis (LTSM) 1110 to obtain an analysis and/or translation 1111. The invention is not limited to the above example or combination.

Those skilled in the state of the art will recognize that the invention is also applicable to analyze text for many other purposes than translation. Using this text analysis with Internet search engines, database searches, spell checkers, etc. will improve their outcome.

All the methods described in the present patent can be used on servers or on end-user devices (computers, cell phones, smart phones, and all kind of electronic devices), with or without a network connection.

All the methods described in the present patent can be used in cloud computing.

All the methods described in the present patent can be used in real time, or in batch mode, or in preprocessed treatments.

Understanding of a text is directly linked to the good analysis of this text.

Search queries are made of words and/or signs so they are considered as documents, all the methods described in the present patent can be used on this kind of documents called search queries.

When the total analysis of documents in natural language is made, we can use methods for conducting searches with multi-levels semantic and contextual analysis.

When a search is made on a search engine, the user specifies a few words in his/her search query, then the search engine provides a very large number of responses.

These responses are those that are possible, then we must identify those most relevant to the user. Ideally these responses are classified by descending order of relevance, the most relevant responses being placed first, so that the user has access to the most relevant responses.

For example, a method that is currently used to increase the relevance of the displayed results is to determine the popularity of websites, for example by identifying the links to these websites.

But search engines do not analyze the relevance of found websites in comparison to the search query.

A method to increase the relevance in the ranking of proposed responses is to analyze the websites in their content and to top ranking websites whose context is closer to the context of the search query.

A system analyzing the context of websites and the context of the search query permits to determine the degree of relevance of found websites in comparison to the search query.

This method is also very fast and consumes little computing resources when processing the search query and when analyzing websites.

Search engines list the presence of words in websites, and they index them. This analysis is superficial. A perfect search engine would understand exactly the user's request and return him/her exactly what he/she wants.

To achieve this goal, it is imperative to have a deep analysis of websites and of documents in general (emails, messages, short messages, voice, etc.)

By deeply analyzing sentences of websites (or documents in general, texts, emails, messages, short messages, search queries, SMS, chat, voice, etc.) we obtain all parameters for each word (connotations, grammatical types, etc.).

So we can go further in the analysis of websites (or documents in general, texts, emails, messages, short messages, search queries, SMS, chat, voice, etc.) to improve website indexing refining search engines' results.

To make a good in-depth analysis of websites' content (or documents in general, texts, emails, messages, short messages, voice, etc.), we must learn the complete structure of every sentence, and solve all the grammatical and semantic ambiguities. This is the analysis phase which our invention facilitates by resolving grammatical and semantic ambiguities.

To index words correctly on websites (or documents in general, texts, emails, messages, short messages, voice, etc.), we must learn the grammatical type of each word and its root.

For example in French we can have three sentences: “il FERME la porte” (he closes the door), “le fruit est FERME” (the fruit is firm), “les animaux sont dans la FERME” (the animals are in the farm).

Therefore we must solve grammatical ambiguities on words and determine if the word “FERME” is the verb “to close”, the noun “farm”, the qualifying adjective “firm”.

To remove grammatical ambiguities, a method is to use artificial intelligence as explained before. For the analysis of search queries in natural language, we use also this method.

Another problem is that a word can have several possible meanings, it is very common.

For each meaning a connotation is linked, for example in French the verb “VOLER” (“to fly” or “to steal”) may have:
an “Aviation” connotation: “l'avion vole” (“the airplane flies”),
a “Legal” connotation: “le voleur vole” (“the thief steals”),
a “Zoology” connotation: “l'oiseau vole” “(the bird flies”).

But for properly indexing a document we need to know the meaning of the word, and so the connotation of this word in this context.

To solve the semantic ambiguities of a word, a method is to use words surrounding this word (in the same sentence or in the text).

With the system of semantic analysis using surrounding words we have for each word the connotation related to the context:

For example: “Voler” (“to fly” or “to steal”) may be related to “Aviation” or “Legal” or “Zoology”.

If we analyze words surrounding the word “voler”:
if there are words like: “avion” (“airplane”), “pilote” (“pilot”), etc, it is an “Aviation” connotation,
if there are words like: “voleur” (“thief”), “cambrioleur” (“burglar”), etc, it is a “Legal” connotation,
if there are words like: “oiseau” (“bird”), “insecte” (“insect”), etc, it is a “Zoology” connotation.

In order to easily extend this method, we can also use synonyms of surrounding words.

For example in the database for the word “voler” (“to fly”) there is the “Aviation” connotation with related surrounding words “avion” (“airplane”), “pilote” (“pilot”), etc.

In a database of synonyms there are as synonymous for “avion” (“airplane”): “bimoteur” (“twin-engines”), “quadrimoteur” (“four-engines”), “planeur” (“glider”), “Boeing”, “Airbus”, etc.

If in the document there is the sentence “le quadrimoteur vole” (“the four-engines flies”) we known that “vole” (“flies”) has a clear “Aviation” connotation.

Surrounding words are not necessary immediately adjacent to a word, they may be anywhere in a sentence or text. They are used to solve semantic ambiguities, they are not considered as lexical units or semantic units.

This method is used to analyze websites to index and also to analyze the search queries.

We can also solve semantic ambiguities (different meanings of a word) that are not clear by using clear connotations that surround them (we know clearly the meaning of those words, and so the linked connotations of those words).

For example: “l'avion vole” (“the airplane flies”).

For the word “avion” (“airplane”) there is no ambiguity, this word has always an “Aviation” connotation, but on the word “voler” (“to fly”) there is an ambiguity, what is the connotation: “Aviation”, “Legal” or “Zoology”?

The fact that the word “avion” (“airplane”) has a clear “Aviation” connotation permits to determine that the word “voler” (“to fly”) has also an “Aviation” connotation.

To analyze the websites (or documents in general, texts, emails, messages, short messages, search query, SMS, chat, voice, etc.) we must know in which language they are written, then we use appropriate algorithms for this language, each language has its specificities, it is necessary to have specific algorithms for each language.

We must also determine the language of the search query to analyze it correctly.

There are two distinct tasks to perform:
Analyze in depth the websites (or documents in general, texts, emails, messages, short messages, etc.), and index obtained informations, this task is performed by specialized softwares known as spiders, websites are analyzed from time to time to see if the content has changed.

This analysis is very fast with algorithms using methods of this patent.

Connotations for each page and each website are stored at the same time as other data relating to these pages.
Analyze in depth the search query made by the user, this is performed in real time.

Connotations are deducted automatically from the analysis of search queries.

Refining the search:

Another method is to enable the user to specify in a list, which connotations he/she wants, or even those he/she excludes for the search.

When the search engine displays responses, several connotations emerge.

The user selects the connotation interesting him/her.

For example, a query: “Harry Potter” will list websites about books as well as films.

Two clear connotations emerge: “Literature” and “Cinema”, by clicking on the chosen connotation, the search is accurate.

To extend the search to a more important collection than basic search made with the search query, we can use synonyms of words that are in the search query.

For example: for a search query “house buying”:
“house” has for synonyms: “apartment”, “studio”, “building”, “villa”, “housing”, etc,
“buying” has for synonyms: “purchasing”, “rental”, “acquisition”, etc.

Using this method the search shows also the results for: “studio acquisition”, “house purchasing”, “apartment rental”, etc.

Sorting these results brings out relevant websites that would not appear with the simple start search query.

Because very often the user does not make the best search query, this method allows a broader search. The list of synonyms that will be used can also be displayed to the user who validates them or not.

With the connotations system, for each page of each website we have a ranking of connotations which allows an evaluation of the real content of the website, and not merely a superficial analysis.

For example the search query: “chocolate cake recipe”, this search query has a connotation “Cooking” because:
the word “chocolate” has a “Cooking” connotation,
the word “cake” has a “Cooking” connotation,
the word “recipe” has a “Cooking” connotation.

So websites that must be placed at the top of the results among websites with the three words will be those where there is a strong “Cooking” connotation because it has been identified in the websites words such as: “cook”, “cooking”, “oven”, “flour”, etc, which have this connotation and those websites having for example a total ranking: “Cooking”: 100, “Trade”: 5, “Sport”: 5, etc.

For example the search query “buy chocolate cake”, this search query has a “Trade” connotation and a “Cooking” connotation because:
the word “buy” has a “Trade” connotation,
the word “chocolate” has a “Cooking” connotation,
the word “cake” has a “Cooking” connotation.

So websites which must be placed at the top of the results will be those where there are strong “Trade” and “Cooking” connotations because it has been identified in these websites words like:
“shop”, “shopping”, “sale”, “purchase”, etc, which have the “Trade” connotation,
“cake”, “pastry”, “chocolate”, etc, which have the “Cooking” connotation, and which will have for example a total scoring: “Trade”: 100, “Cooking”: 100, “Sport”: 5, etc.

The connotations are deducted for each page, and so the total connotations of a website which is a set of pages.

For a greater efficiency we can subdivide connotations into sub-connotations, for example the general connotation “Sport” may have a “Team-Sport” sub-connotation, itself subdivided into “Soccer”, “Rugby”, “Volleyball”, etc.

For example the general connotation “Music” may have sub-connotations: “Rock”, “Rap”, “Hip-Hop”, “Country”, “Jazz”, “Punk”, “Classic”, etc.

The “Rock” sub-connotation being itself subdivided into “Hard-Rock”, “Pop-Rock”, “Progressive-Rock”, etc.

Many words have regional variations, such as South American Spanish, with words having Mexican connotations, etc. And the same for the British-English or American-English.

We can use those informations for better searches.

All this provide a very precise analysis of websites (or documents in general, texts, emails, messages, short messages, voice, etc.).

This analysis is: standardized, easy to reference, fast to access, scalable, etc.

This is an important step towards a true “Semantic Web” which is not limited to the mere use of meta-tags that web-masters have placed (or not) in the head of websites.

Once the websites corresponding to the search request are found, they must be ranked by order of relevance. This classification should be performed in real time, speed is necessary and it is a big constraint for used algorithms. The use of connotations makes this ranking very quick. Few methods allow an accurate classification so quickly.

Many search strategies can be achieved using this concept of websites connotations indexing.

To analyze websites connotations we use a database for each language with all the words and connotations associated with them.

Structure of a database with connotations:

For each basic word in each language we have the basic word and the connotation associated with it, for example: “kitchen”: “Cooking”.

Most words may have several connotations, in this case we indicate also the surrounding words associated with this connotation, for example as explained before (in French): “voler” (to fly, to steal):
Aviation (“avion” (“airplane”), “pilote” (“pilot”), etc.),
Zoology (“oiseau” (“bird”), “insecte” (“insect”), etc.),
Legal (“voleur” (“thief”), etc.).

This method uses a small storage capacity, websites analysis is fast, and search queries treatment is fast (analysis of search query, ranking of responses).

Generally search engines perform searches on websites. In this patent, methods are explained for search engines and websites, but it is obvious to those skilled in the state of the art that the same methods can be applied to the analysis of all kind of documents, emails, SMS, chat, news, voice, messages, and all types of documents that can be processed by computers, smart phones, phones, etc.

Usually advertisings displayed to the user are related to words (or group of words) contained in queries provided to search engines, or in the displayed documents (websites, emails, texts, messages, short messages, SMS, chat, etc).

So the user has an advertising relevant to his/her interests.

With methods describe before in the present patent, we have much more informations, for example connotations that are linked to words of documents.

It is also possible to display advertisings related to those connotations or sub-connotations or mix of connotations.

For example: “Music”, “Culture”, “Travel”, “Sport”, “Team-Sport”, “Soccer”, “Rugby”, “Computer” and “Music”, “Computer” and “Games”, etc.

For example: with a search query about a pop singer we can display advertisings for other pop singers. It is also possible to display advertisings related to combinations of words and connotations, for example: the word “shoes” and the “Sport” connotation, the word “boat” and the “Sport” connotation, or the word “boat” and the “Travel” connotation, etc.

It is also possible to display advertisings related to synonyms of words:

for example the search query “purchase car” can generate displaying of advertisings for “buy car”, “car sales”, “vehicle sales”, etc.

It is also possible to display advertisings related to combinations of connotations and synonyms of words.

It is possible to link informations that are known using the methods of the invention and informations about the user: visited websites, previous search queries, preferences, environment, etc.

For example if the user is having a “PC” no advertisement of software for “MAC” would be displayed i.e. office suite that have a version for “PC” and a version for “MAC”.

To better target advertising:

In the databases which are not only simple dictionaries we can have informations such as proper noun of brands, etc.

For example we can have the name of the firm, the nationality of the firm, the category and subcategories of an object, the price range, etc.

For example we can have “M3” with the following informations: “Automobile” “BMW” “German-Maker” “Sport-vehicle” “Sedan”, etc. So we can display advertisings for example for other car makers in the same category of vehicle and price.

As said before, a good analysis of documents is important on Internet for search engines and for targeted advertising. Usually search engines and targeted advertising use keywords found in websites pages (it can be all kind of documents, SMS, chat, short message, email, voice, etc) or in search queries. But sentences are not fully analyzed.

By analyzing deeply sentences we can have all grammatical characteristics of words and their relations between them.

Identifying all semantic informations of those words we obtain a real analysis of documents to index on search engines or for better targeting advertisings relating to interests of the user.

Solving semantic ambiguities we avoid errors on words having multiple meanings, and we avoid displaying wrong advertisings.

For example: in French “un vol” may be “a flight” or “a steal”, in the sentence “un vol de bijoux a été commis à Paris” (“a steal of jewelry has been committed in Paris”) it is the sense “steal”, but usually targeted advertising are proposing “a flight to Paris” which is not appropriate.

We avoid errors on words having multiple grammatical types, for example: “like” may be the verb “to like”, a qualifying adjective, or a preposition.

Analyzing deeply sentences we have informations about tenses of verbs (present, past tenses, future tenses), forms of verbs (affirmative, negative, interrogative, intero-negative), if a verb is with an active or a passive voice, etc.

Sentences are analyzed deeply so we know how words are aggregated in Nominal Groups, Verbal Groups, Adjectival Groups, Clauses.

And we know which are subjects of verbs and complements, etc.

For example: “this big white car runs really fast on the motorway”:
“this big white car” is a Nominal Group subject of the Verbal Group,
“runs really fast” is a Verbal Group,
“on the motorway” is a Nominal Group complement of the Verbal Group.

Rating words:

Usually search engines and targeted advertising use keywords found in documents, it is interesting to know which words are the more pertinent for search engines or targeted advertising, if we have a rating on those words it is a good improvement. More the word is potentially important for search engines or targeted advertising more the rating is high, less the word is potentially important for search engines or targeted advertising less the rating is high.

Knowing the structure of sentences we can have additional informations on words.

For example: “I like this car”.

We know that “this car” is complement of the verb “to like”, so informations available on the verb are available for his complement.

The verb “to like” has a positive connotation, so in the database we add a “positive” connotation to the verb “to like”.

So when “I like this car” is analyzed we have a positive rating on the word “car”, for example +1.

If we have “I hate this car”, the rating is for example −1.

For example in the sentence “I don't like this car” we see that the verb “to like” has a “positive” connotation, but the verb is in a negative form, so the rating of “car” which was +1 with “I like this car” is becoming −1 with “I don't like”.

For example in the sentence “I will buy a car” we see the verb “to buy” which has an interesting connotation for advertising because it is indicating a potential buyer, so the rating on “car” will be higher.

For example in the sentence “I want to buy a car” we see the verb “to buy” and the verb “to want”, so the rating on “car” will be even higher.

For example in the sentence “I really like this car” the rating on “car” will be higher than in the sentence “I like this car.

For example in the sentence “I will buy a car” the rating on “car” will be higher than in the sentence “I have bought a car” because a verb indicating a future action has an higher rating than a verb indicating a past action.

Rules of interaction between words are linked to semantic properties of words, to grammatical type of words and to grammatical relations between those words in the sentence.

They are rules of interaction between words in Nominal Groups, in Verbal Groups, in Adjectival Groups, in Clauses.

They are rules of interaction between Nominal Groups and Verbal Groups and Adjectival Groups and Clauses.

The rating of a word is linked to its semantic meaning, and to its grammatical type. Ratings of other words linked to that word are modified by the rating of that word, and the rating of that word is modified by the ratings of other words linked to that word.

The invention is not limited to the above examples or language. Those skilled in the state of the art will recognize that the invention is applicable to infinite combinations of words and meanings.

After the total analysis of the document, a total ranking of connotations and/or words ratings is made, and the more appropriate advertisings are selected for displaying.

Usually an advertising generates money only if the user clicks on it, so more advertisings are linked to interests of the user more the probability of clicking in high.

Even in the case of advertising banners displayed without clicking, it is more pertinent to display advertisings linked to interests of the user.

For example it is not interesting to display an advertising about a product if the user has said in an email “I hate this product”, but if the user has said in an email “I will probably buy this type of product” the interest is very high.

We have a lot of applications handling very short documents (search queries, SMS, short messages, “twit”, chat, etc).

Space where advertisings may be displayed is limited, moreover on mobile devices (phones, smart phones, etc), so displayed advertisings must be optimized.

Having a lot of pertinent informations about words with positive or negative rating it is possible to optimize displayed advertisings. The invention is not limited to those examples; those skilled in the state of the art will recognize that the invention is applicable for other specific grammatical or linguistic informations.

### BRIEF DESCRIPTION OF THE DRAWINGS

FIG. 1 shows information flow, control, and propagation in a block diagram following an Original Text through to its Analyzed and/or Translated Text.

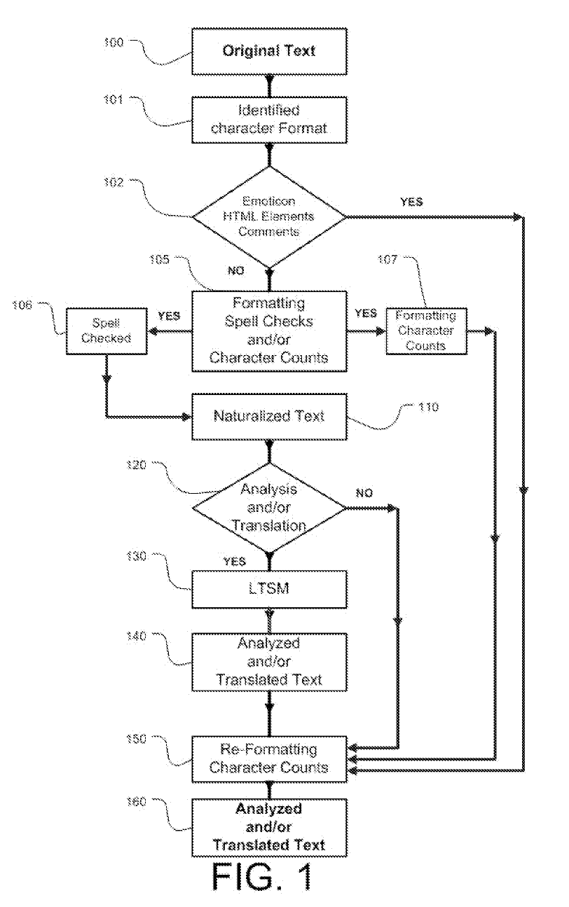

FIG. 2 shows an example of basic dictionary tables for any language with all required information.

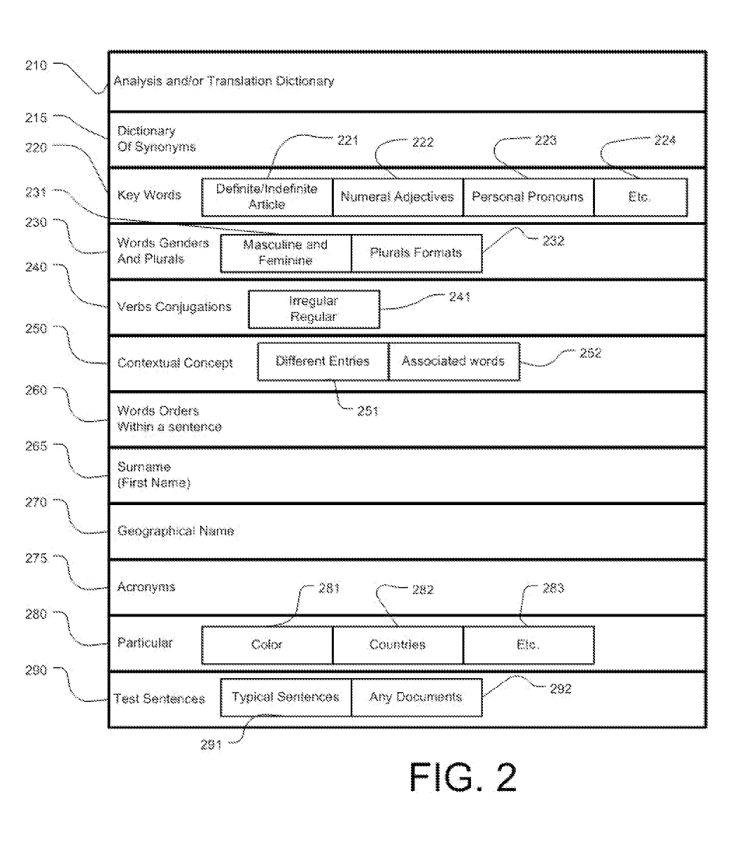

FIG. 3 shows an example of word grammatical analysis for each word in a text stream.

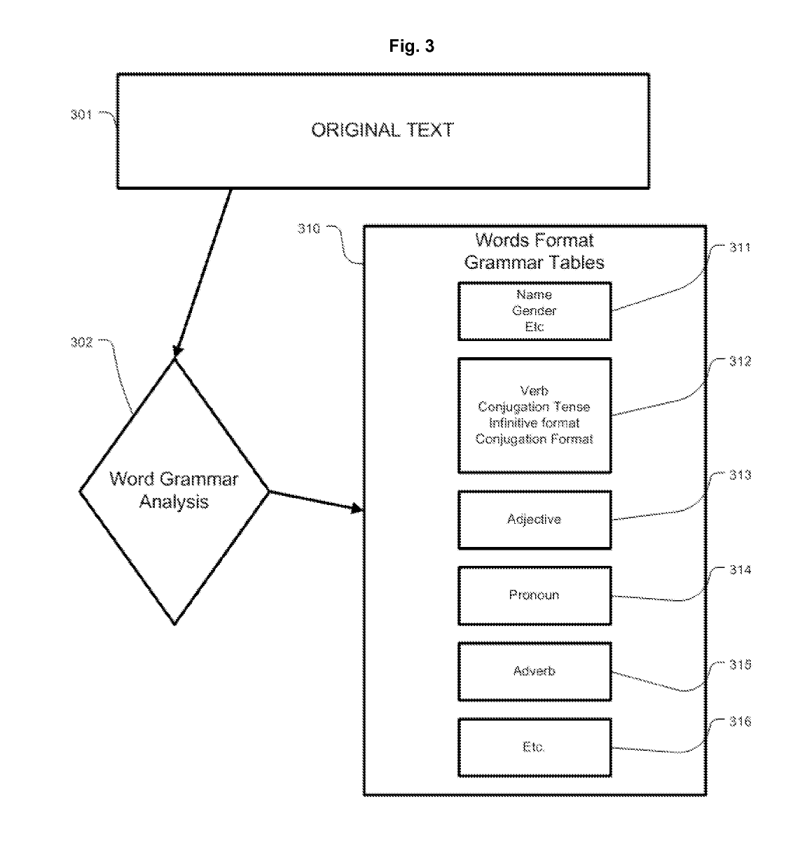

FIG. 4 shows an example of a Cross Dictionary table in French.

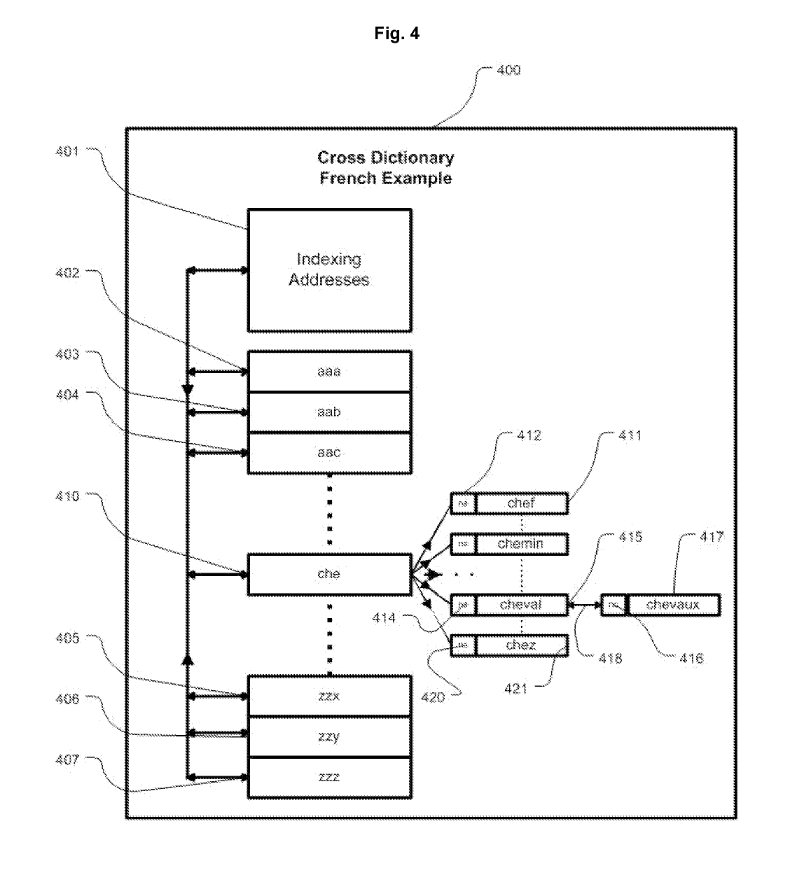

FIG. 5 shows an example of the relationship between a word in a Cross Dictionary table in French to a corresponding word in the Cross Dictionary table in English.

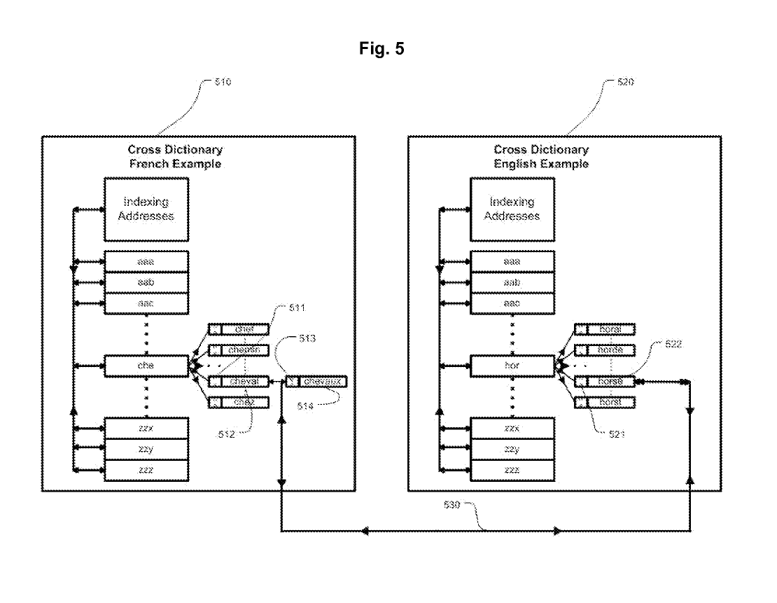

FIG. 6 shows the use of Artificial Intelligence to obtain the best analysis and/or translation from a French sentence to an English sentence.

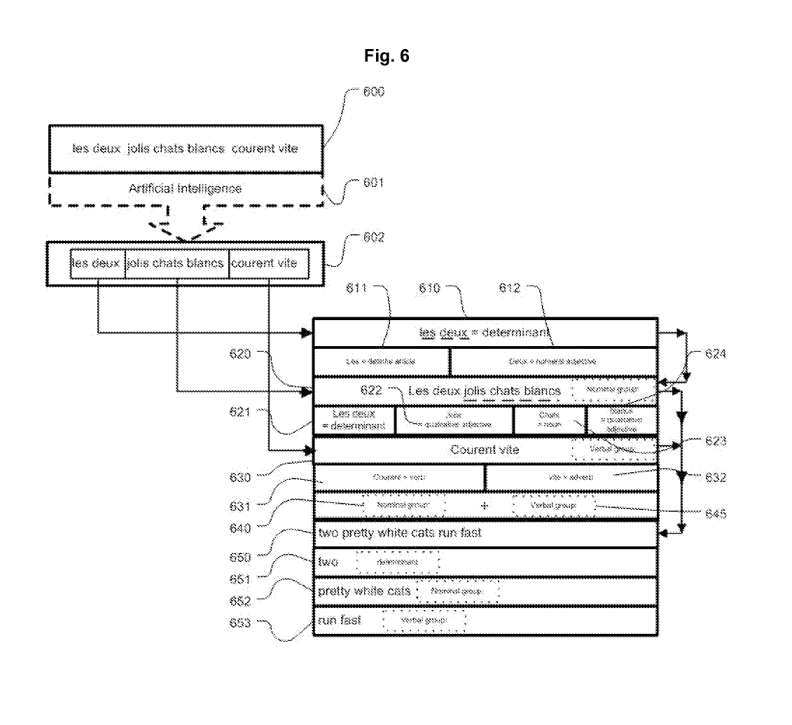

FIG. 7 shows the use of Artificial Intelligence to obtain a priority structure in English.

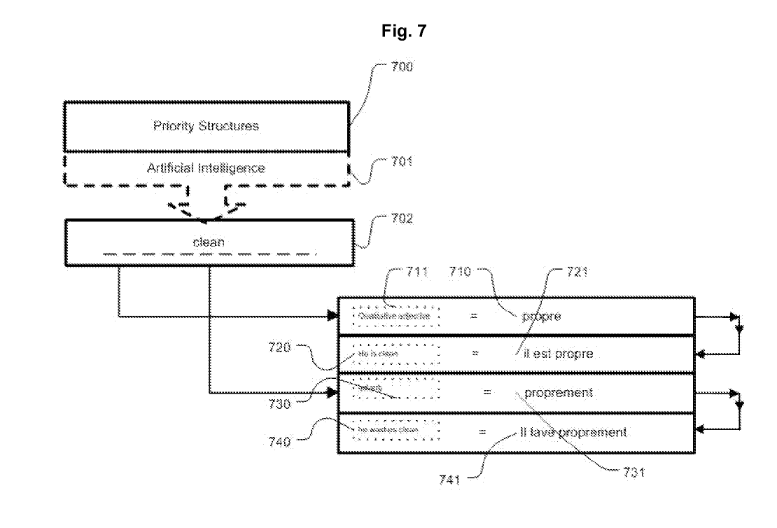

FIG. 8 shows the use of Contextual Analysis to obtain the proper meaning of the French word “glace” that has multiple meanings by examining nearby text.

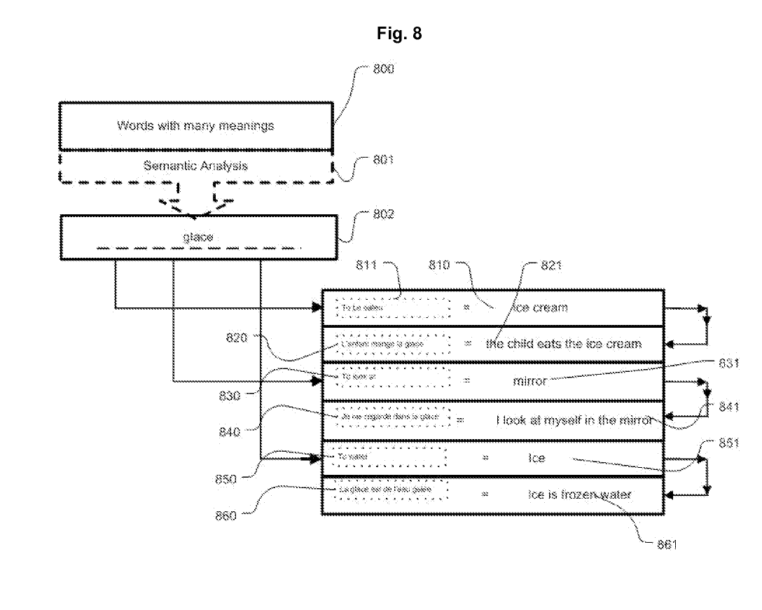

FIG. 9 shows the use of Contextual Analysis to obtain the proper meaning of the French word “voler” that has multiple meanings by examining nearby text.

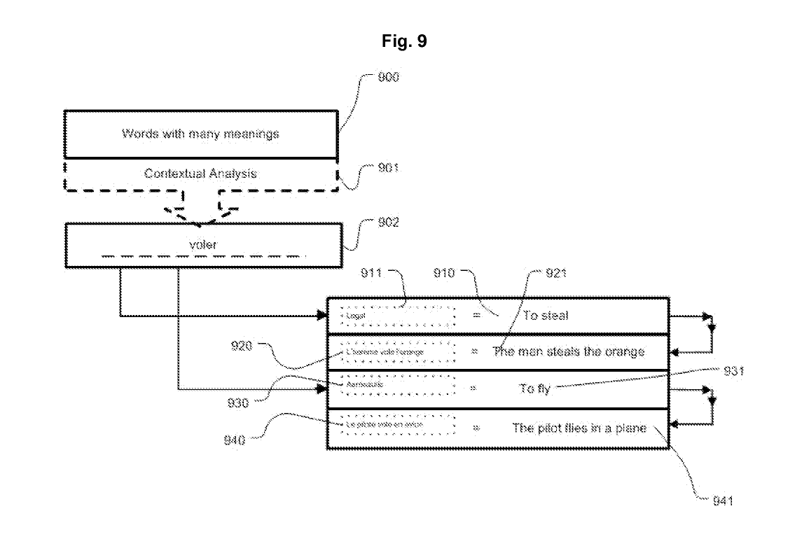

FIG. 10 shows the use of Semantic Analysis to extend Contextual Analysis through the use of a synonym dictionary to analyze and/or to translate accurately the word “glace”.

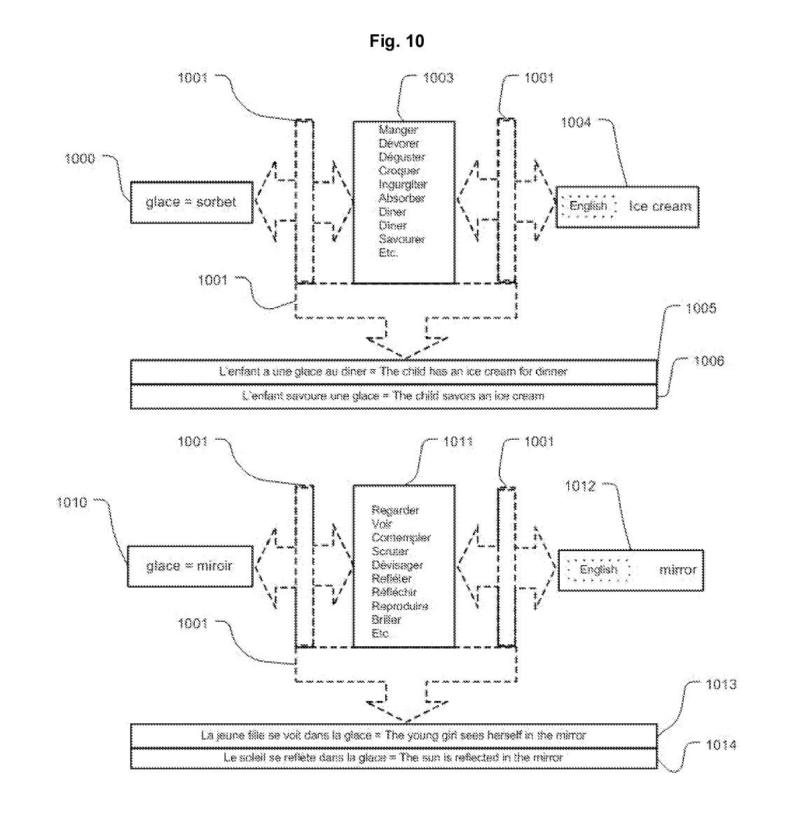

FIG. 11 shows the use of Semantic Analysis translation to augment a Statistical analyzer and/or translator to improve the analysis and/or translation quality.

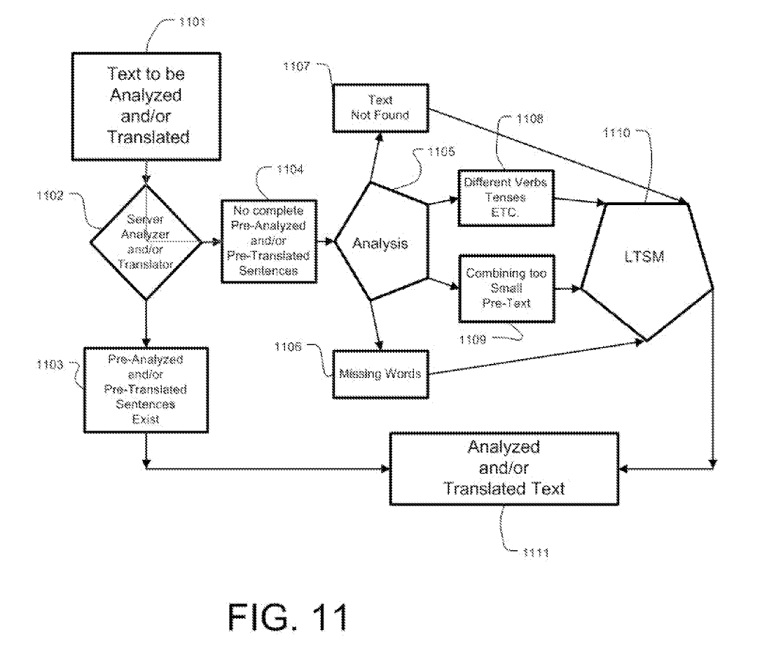

What is claimed is:

1. A method to obtain a better understanding/analysis and/or translation of any document's content by using Contextual Analysis and/or Semantic Analysis and/or Artificial Intelligence and/or connotations of words an/or words surrounding other words and/or synonyms of words in Semantic Analysis and/or by analyzing grammatical relations of words between them.

2. A method according the previous claim to improve the indexing of any document's content for search engines and/or the relevance of search engines' results.

3. A method according the claim 1 for displaying targeted advertisements

4. A method for displaying targeted advertisements related to:
the connotations of words that appear in any documents' content and/or in search engines' queries and/or,
synonyms for words that appear in any documents' content and/or in search engines' queries and/or,
combining words and connotations associated with words that appear in any documents' content and/or in search engines' queries and/or,
the rating of words that appear in any documents' content and/or in search engines' queries, this rating depending of semantic analysis and/or grammatical analysis and/or connotations of words and/or grammatical relations of words between themselves.
